(19) United States
(12) Patent Application Publication
(10) Pub. No.: US 2006/0209726 A1
(43) Pub. Date: Sep. 21, 2006

(54) Information network control method and telecommunication node

(75) Inventor: Tatsuya Kawasumi, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED

(21) Appl. No.: 11/362,329

(22) Filed: Feb. 24, 2006

(30) Foreign Application Priority Data
Mar. 15, 2005 (JP) 2005-073700

(51) Int. Cl. H04L 12/28

(52) U.S. Cl. 370/258

(57) ABSTRACT

The present invention is to provide a control method for an information network connecting a plurality of telecommunication nodes by a ring transmission path and giving a plurality of priorities to frames which are exchanged among the telecommunication nodes, comprising the processes of: recognizing a bandwidth assurance value set up for each of the telecommunication nodes on the ring transmission path for each layer of the priorities; and judging whether or not a sum of the total of the bandwidth assurance value at the present and a newly allocated value of the bandwidth assurance value exceeds a physical transmission bandwidth of the ring transmission path when a discretionary one of the telecommunication nodes accepts an allocation of the bandwidth assurance value anew.

### BACKGROUND OF THE INVENTION

1. Field of the Invention

The present invention relates to a network control method, telecommunication node, network management apparatus, and information network system, and in particular to a technique effectively applicable to an information network allowing a setup for reserving a telecommunication bandwidth.

2. Description of the Related Art

The RPR (Resilient Packet Ring) technique specified by IEEE 802.17-2004 allows three priority ratings, i.e., class A through C for a frame propagating through a ring. The class A and class B frames require an absolute assurance of a transmission bandwidth for sending a frame out to an RPR ring from an RPR station located on the RPR ring, which is called a CIR (Committed Information Rate). In order for the transmission bandwidth defined as a CIR to be absolutely assured on the RPR ring, the total of CIRs defined by each RPR station located on the RPR ring has to be smaller than the transmission bandwidth thereof.

For instance, let it assume that the transmission bandwidth of an RPR ring is one Gbps and each one of six RPR stations existing on the RPR ring uniformly set the class A CIR at 200 Mbps. In this event, the total of the CIRs on the entire ring exceeds the transmission bandwidth of the RPR ring (i.e., 200 Mbps×6=1.2 Gpbs). Such a CIR setup precludes an absolute assurance for a transmission bandwidth. Accordingly, the class A CIR value set by each RPR station is notified to the other RPR stations by using a control frame flowing in the RPR ring, thereby enabling each RPR station to know the total of the class A CIRs which are currently reserved for the RPR ring according to the IEEE 802.17-2004.

The IEEE 802.17-2004 lets the class A further define two subclasses, i.e., a subclass A0 and subclass A1, with the subclass A0 further specifying an operation for each RPR station notifying the RPR ring of the CIR value reserved by the own station as noted above, while the subclass A1 not specifying as such, nor a class B CIR value specifying a notification to the RPR ring as with the subclass A1.

The fact that the subclass A1 and class B CIRs are not notified to the RPR ring precludes a prevention of each RPR station on an RPR ring setting the subclass A0/A1 and class B CIR values where the total of which exceeds the transmission bandwidth, and a warning when such a setting has resulted.

For example as shown by FIG. 1, in the case of transmitting among four RPR stations (i.e., 2-1, 2-2, 2-3 and 2-4), each station sets respective CIR values for a subclass A0, subclass A1 and class B (i.e., m1, 11 and k1 through m4, 14 and k4). The subclass A0 CIR value is notified from the station which set the value to the other stations by using a control frame. The value of the subclass A0 CIR=m1 Mbps (megabit per second) at the RPR station 2-1 for example is notified to all the other RPR stations 2-2, 2-3 and 2-4. And the RPR station 2-1 receives the subclass A0 CIR values respectively set by the other stations. This enables each RPR station to know how much A0 CIR (=m1+m2+m3+m4) being reserved in the entire ring. Meanwhile, an A1 CIR or B CIR is never notified mutually among the RPR stations. Under such a circumstance, each RPR station is only capable of knowing an assumed spare bandwidth by depending on the expression (1) below, in order to understand how many spare bandwidth out of the transmission bandwidth, i.e., “n” Mbps, possessed by the RPR ring:
Assumed spare bandwidth=n−(m1+m2+m3+m4) (1);

whereas the actual spare bandwidth is as expressed by (2) below:
Actual spare bandwidth=n−(m1+m2+m3+m4)−(11+12+13+14)−(k1+k2+k3+k4) (2)

If each RPR station sets CIRs for a subclass A1 and/or class B based on the assumed spare bandwidth, the total CIRs for the entire RPR ring possibly exceeds the transmission bandwidth of the RPR ring, resulting in being unable to assure the transmission bandwidth for the subclass A1 and class B. Incidentally the subclass A0 is continuously secured for a bandwidth by using an IDLE frame, thereby the transmission bandwidth being securely assured.

A patent document 1 has disclosed a technique for accomplishing a fair distribution of an AF class output bandwidth by performing a bandwidth redistribution to each class of AF/EF in an MPLS network within each class, whereas having no reference to a technique for managing a relationship between the total of bandwidth allocated to each class hierarchy and the bandwidth of a physical medium.

[Patent document 1] a laid-open Japanese patent application publication No. 2004-193975

### SUMMARY OF THE INVENTION

A purpose of the present invention is to provide a technique for enabling an accurate management of a total bandwidth allocated to each hierarchy based on a physical bandwidth of an information network in the information network in which priorities of frames that are exchanged among telecommunication nodes are hierarchically layered.

Another purpose of the present invention is to provide an accurate bandwidth assurance within an RPR ring not only for the subclass A0 CIRs but also for the subclasses A1 and class B CIRs in the RPR ring.

Yet another purpose of the present invention is to accurately deter a wrong bandwidth assurance by considering not only the subclass A0 CIRs but also the subclass A1 and class B CIRs in the RPR ring.

A first aspect of the present invention is to provide a control method for an information network connecting a plurality of telecommunication nodes by a ring transmission path and giving a plurality of priorities to frames which are exchanged among the telecommunication nodes, comprising the processes of: recognizing a bandwidth assurance value set up for each of the telecommunication nodes on the ring transmission path for each layer of the priorities; and judging whether or not a sum of the total of the bandwidth assurance value at the present and a newly allocated value of the bandwidth assurance value exceeds a physical transmission bandwidth of the ring transmission path when a discretionary one of the telecommunication nodes accepts an allocation of the bandwidth assurance value anew.

A second aspect of the present invention is to provide the control method for an information network according to the first aspect, wherein the ring transmission path is an resilient packet ring (RPR) compliant to the IEEE 802.17; the layer comprises a class A, which is made up of a subclass A0 and subclass A1, and a class B; and the bandwidth assurance value is recognized for the class A and class B.

A third aspect of the present invention is to provide a control method for an information network connecting a plurality of telecommunication nodes by a ring transmission path and giving a plurality of priorities to frames which are exchanged among the telecommunication nodes, comprising the processes of: collecting a bandwidth assurance value set up for each of the telecommunication nodes on the ring transmission path for each layer of the priorities by a network management apparatus which manages the telecommunication nodes; and judging whether or not a sum of the total of the bandwidth assurance value at the present and a newly allocated value of the bandwidth assurance value exceeds a physical transmission bandwidth of the ring transmission path by the network management apparatus when a discretionary one of the telecommunication nodes accepts an allocation of the bandwidth assurance value anew.

A fourth aspect of the present invention is to provide the control method for an information network according to the third aspect, wherein the ring transmission path is an resilient packet ring (RPR) compliant to the IEEE 802.17; the layer comprises a class A, which is made up of a subclass A0 and subclass A1, and a class B; and the bandwidth assurance value is collected for the class A and class B.

A fifth aspect of the present invention is to provide a control method for an information network connecting a plurality of telecommunication nodes by a ring transmission path and giving a plurality of priorities to frames which are exchanged among the telecommunication nodes, comprising the processes of: notifying all the telecommunication nodes of a bandwidth assurance value set up for each of the telecommunication nodes on the ring transmission path for each layer of the priorities; and judging whether or not a sum of the total of the bandwidth assurance value at the present and a newly allocated value of the bandwidth assurance value exceeds a physical transmission bandwidth of the ring transmission path when a discretionary one of the telecommunication nodes accepts an allocation of the bandwidth assurance value anew.

A sixth aspect of the present invention is to provide the control method for an information network according to the fifth aspect, wherein the ring transmission path is an resilient packet ring (RPR) compliant to the IEEE 802.17; the layer comprises a class A, which is made up of a subclass A0 and subclass A1, and a class B; and the bandwidth assurance value for the class A and class B is notified from one of the telecommunication nodes to the others thereof.

A seventh aspect of the present invention is to provide a control method for an information network connecting a plurality of telecommunication nodes by a ring transmission path and giving a plurality of priorities to first frames which are exchanged among the telecommunication nodes, comprising the processes of: notifying all the telecommunication nodes of a bandwidth assurance value set up for each thereof in the ring transmission path for each layer of the priorities by using a part of a second frame on another protocol layer for carrying the first frame; and judging whether or not a sum of the total of the bandwidth assurance value at the present and a newly allocated value of the bandwidth assurance value exceeds a physical transmission bandwidth of the ring transmission path when a discretionary one of the telecommunication nodes accepts an allocation of the bandwidth assurance value anew.

An eighth aspect of the present invention is to provide the control method for an information network according the fifth aspect, wherein the ring transmission path is an resilient packet ring (RPR) compliant to the IEEE 802.17, and the second frame is the one compliant to a generic framing procedure (GFP) for carrying the first frame based on the RPR by including it.

A ninth aspect of the present invention is to provide a telecommunication node for constituting an information network by connecting itself to a ring transmission path and giving a plurality of priorities to frames which are flown in the network, comprising: a notification unit for notifying the other telecommunication node of a bandwidth assurance value set up for the own telecommunication node on the ring transmission path for each layer of the priorities; a storage unit for storing the bandwidth assurance values for all the telecommunication nodes connected to the ring transmission path; and a judgment unit for judging whether or not a sum of the total of the bandwidth assurance value in a plurality of the telecommunication nodes at the present and a newly allocated value of the bandwidth assurance value exceeds a physical transmission bandwidth of the ring transmission path when the own telecommunication node accepts an allocation of the bandwidth assurance value anew.

A tenth aspect of the present invention is to provide the telecommunication node according to the ninth aspect, wherein the ring transmission path is an resilient packet ring (RPR) compliant to the IEEE 802.17; the layer comprises a class A, which is made up of a subclass A0 and subclass A1, and a class B; and the storage unit stores the bandwidth assurance value relating to the class A and class B.

An eleventh aspect of the present invention is to provide a network management apparatus for managing an information network connecting a plurality of telecommunication nodes by a ring transmission path and giving a plurality of priorities to frames exchanged among the telecommunication nodes, comprising: a collection unit for collecting a bandwidth assurance value set up for each of the telecommunication nodes on the ring transmission path for each layer of the priorities; and a judgment unit for judging whether or not a sum of the total of the bandwidth assurance value at the present and a newly allocated value of the bandwidth assurance value exceeds a physical transmission bandwidth of the ring transmission path by the network management apparatus when a discretionary one of the telecommunication nodes accepts an allocation of the bandwidth assurance value anew.

A twelfth aspect of the present invention is to provide the network management apparatus according to the eleventh aspect, wherein the ring transmission path is an resilient packet ring (RPR) compliant to the IEEE 802.17; the layer comprises a class A, which is made up of a subclass A0 and subclass A1, and a class B; and the bandwidth assurance value is collected for the class A and class B.

A thirteenth aspect of the present invention is to provide an information network system including a plurality of telecommunication nodes and a ring transmission path interconnecting the telecommunication nodes and giving a plurality of priorities to frames which are exchanged among the telecommunication nodes, wherein each of the telecommunication nodes includes a storage unit for storing the bandwidth assurance values for all the telecommunication nodes connected to the ring transmission path; and a judgment unit for judging whether or not a sum of the total of the bandwidth assurance value in a plurality of the telecommunication nodes at the present and a newly allocated value of the bandwidth assurance value exceeds a physical transmission bandwidth of the ring transmission path when the own telecommunication node accepts an allocation of the bandwidth assurance value anew.

A fourteenth aspect of the present invention is to provide the information network system according to the thirteenth aspect, wherein the ring transmission path is an resilient packet ring (RPR) compliant to the IEEE 802.17; the layer comprises a class A, which is made up of a subclass A0 and subclass A1, and a class B; and the storage unit stores the bandwidth assurance value relating to the class A and class B.

A fifteenth aspect of the present invention is to provide an information network system including a plurality of telecommunication nodes, a ring transmission path interconnecting the telecommunication nodes and a network management apparatus for managing the telecommunication nodes and giving a plurality of priorities to frames which are exchanged among the telecommunication nodes, wherein the network management apparatus includes a collection unit for collecting a bandwidth assurance value set up for each of the telecommunication nodes on the ring transmission path for each layer of the priorities a judgment unit for judging whether or not a sum of the total of the bandwidth assurance value at the present and a newly allocated value of the bandwidth assurance value exceeds a physical transmission bandwidth of the ring transmission path by the network management apparatus when a discretionary one of the telecommunication nodes accepts an allocation of the bandwidth assurance value anew.

A sixteenth aspect of the present invention is to provide the information network system according to the fifteenth aspect, wherein the ring transmission path is an resilient packet ring (RPR) compliant to the IEEE 802.17; the layer comprises a class A, which is made up of a subclass A0 and subclass A1, and a class B; and the collection unit collects the bandwidth assurance value relating to the class A and class B.

A seventeenth aspect of the present invention is to provide a control program for controlling a telecommunication node constituting an information network by connecting itself to a ring transmission path and giving a plurality of priorities to frames which are flown in the information network, wherein the control program makes the telecommunication node function as notification unit for notifying the other telecommunication nodes of a bandwidth assurance value set up for the own telecommunication node on the ring transmission path for each layer of the priorities; storage unit for storing the bandwidth assurance values for all the telecommunication nodes connected to the ring transmission path; and judgment unit for judging whether or not a sum of the total of the bandwidth assurance value in a plurality of the telecommunication nodes at the present and a newly allocated value of the bandwidth assurance value exceeds a physical transmission bandwidth of the ring transmission path when the own telecommunication node accepts an allocation of the bandwidth assurance value anew.

An eighteenth aspect of the present invention is to provide a control program for a network management apparatus which manages an information network connecting a plurality of telecommunication nodes by a ring transmission path and giving a plurality of priorities to frames which are exchanged among the telecommunication nodes, wherein the control program makes the network management apparatus carry out the processes of: collecting a bandwidth assurance value set up for each of the telecommunication nodes on the ring transmission path for each layer of the priorities; and judging whether or not a sum of the total of the bandwidth assurance value at the present and a newly allocated value of the bandwidth assurance value exceeds a physical transmission bandwidth of the ring transmission path when a discretionary one of the telecommunication nodes accepts an allocation of the bandwidth assurance value anew.

### BRIEF DESCRIPTION OF THE DRAWINGS

FIG. 1 is a conceptual diagram describing a setup and operation of a CIR in an RPR ring as a reference technique of the present invention;

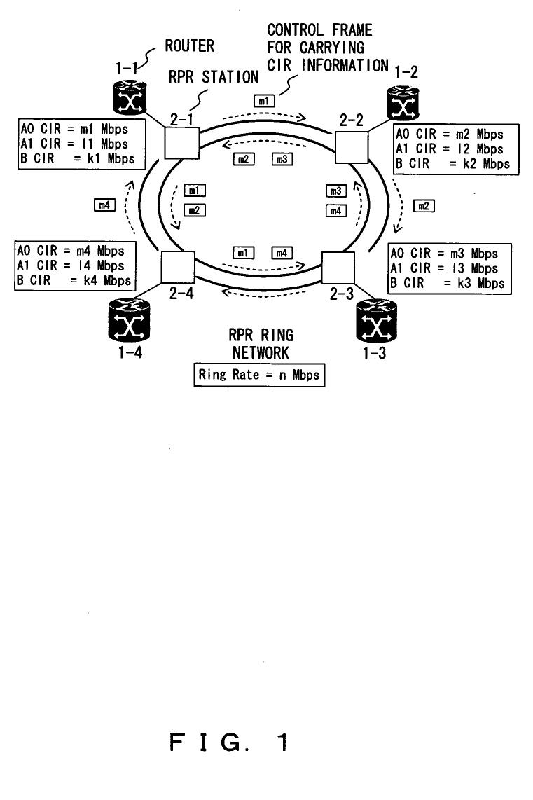

FIG. 2 is a conceptual diagram exemplifying a comprisal of an information network system according to an embodiment of the present invention;

FIG. 3 is a conceptual diagram exemplifying a comprisal of a network management system constituting an information network system according to an embodiment of the present invention;

FIG. 4 is a conceptual diagram exemplifying a structure of a data base possessed by a network management system according to an embodiment of the present invention;

FIG. 5 is a flow chart exemplifying an operation of a network management system according to an embodiment of the present invention;

FIG. 6 is a conceptual diagram showing an example configuration of an RPR station constituting an information network according to another embodiment of the present invention;

FIG. 7 is a conceptual diagram exemplifying a structure of a topology data base comprised by an RPR station constituting an information network according to another embodiment of the present invention;

FIG. 8 is a conceptual diagram exemplifying a structure of a control frame exchanged between RPR stations constituting an information network according to another embodiment of the present invention;

FIG. 9 is a conceptual diagram exemplifying a structure of a control frame, in more detail, exchanged between RPR stations constituting an information network according to another embodiment of the present invention;

FIG. 10 is a conceptual diagram exemplifying an information setup of an ATD frame exchanged between RPR stations constituting an information network according to another embodiment of the present invention;

FIG. 11 is a conceptual diagram exemplifying a configuration of an RPR unit constituting an information network according to yet another embodiment of the present invention; and

### DESCRIPTION OF THE PREFERRED EMBODIMENTS

The following is a detailed description of the preferred embodiment of the present invention while referring to the accompanying drawings.

### First Embodiment

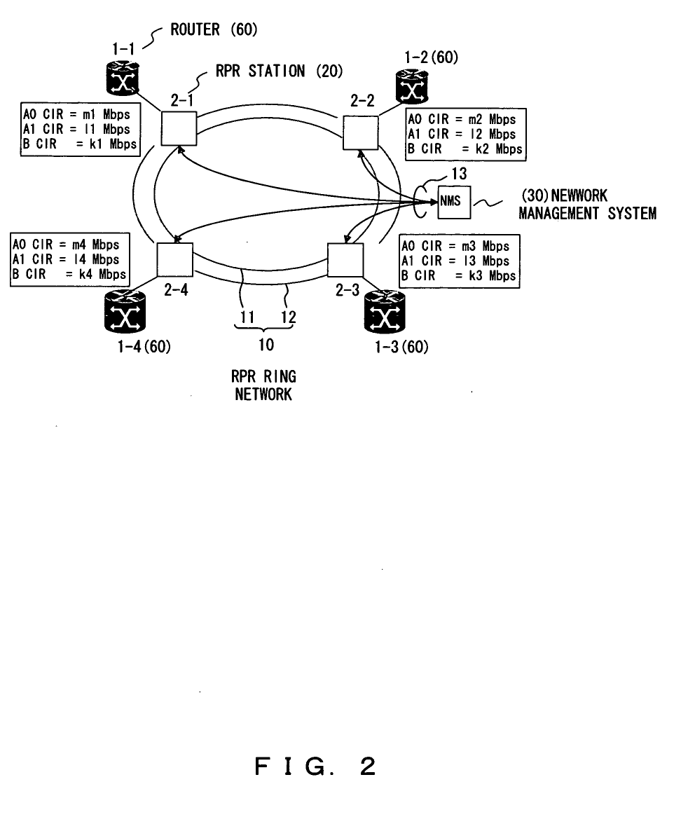

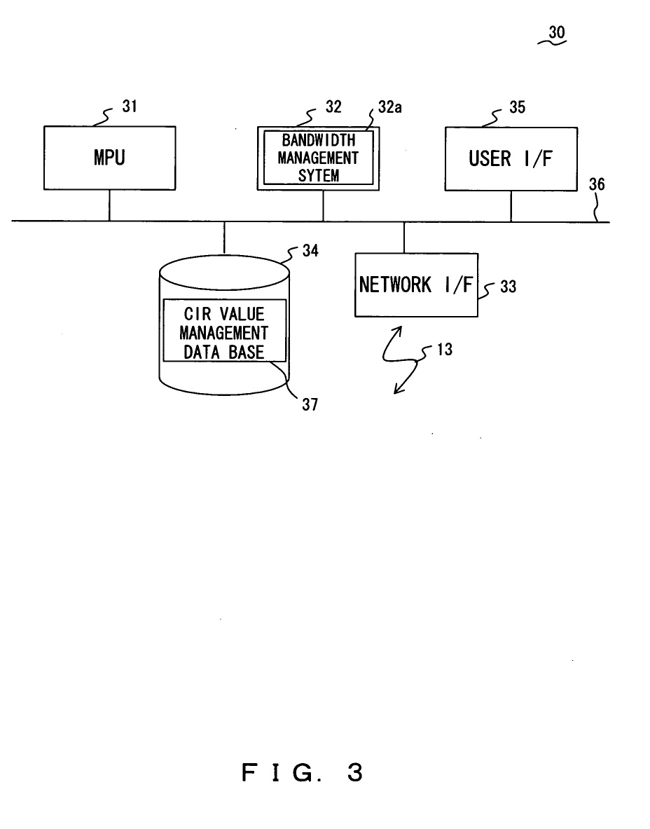

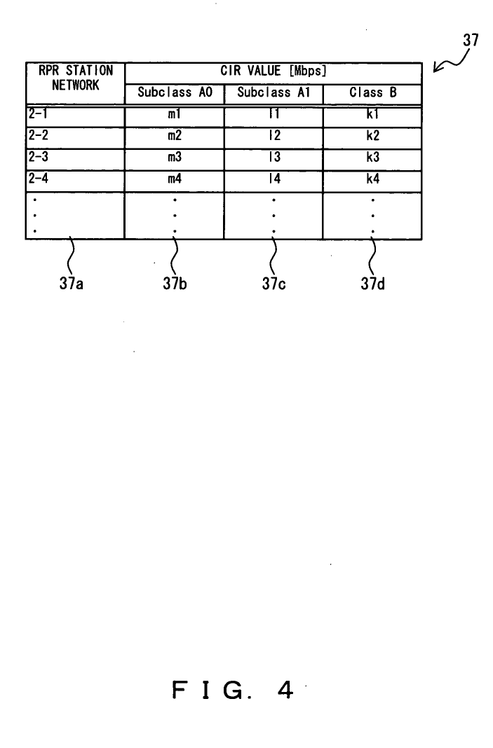

FIG. 2 is a conceptual diagram exemplifying a comprisal of an information network system according to an embodiment of the present invention; FIG. 3 is a conceptual diagram exemplifying a comprisal of a network management system constituting an information network system according to the present embodiment; and FIG. 4 is a conceptual diagram exemplifying a structure of a data base possessed by a network management system according to the present embodiment.

As exemplified by FIG. 2, an information network system according to the present embodiment includes an RPR ring 10, a plurality of RPR stations 20 interconnected by way thereof and a network management system 30.

The RPR ring 10 is dually structured by a ringlet 11 and a ringlet 12 which have mutually opposite transmission directions of information.

Each of a plurality of RPR stations interconnected by the RPR ring 10 is connected to an information network (not shown herein) such as a LAN byway of a router 60. And each RPR station 20 generates a data frame from information received from the LAN by way of the router 60 and relays information between the LANs by way of the RPR ring 10 by using the data frame.

Each RPR station 20 is connected to the network management system 30 by way of a management-use information network 13 such as SONET/SDH (synchronous optical network/synchronous digital hierarchy), other than the RPR, for example.

As exemplified by FIG. 3, the network management system 30 according to the present embodiment comprises an MPU (micro processor unit) 31, a main storage 32, a network interface 33, an external storage apparatus 34, a user interface 35 and a bus 36.

The MPU 31 controls the entirety of the network management system 30 by executing a program (not shown herein) stored by the main storage 32.

The network interface 33 is connected to each of the RPR stations 20 by way of the management-use information network 13 and collects information from the RPR stations 20 by way of the network interface 33 and management-use information network 13.

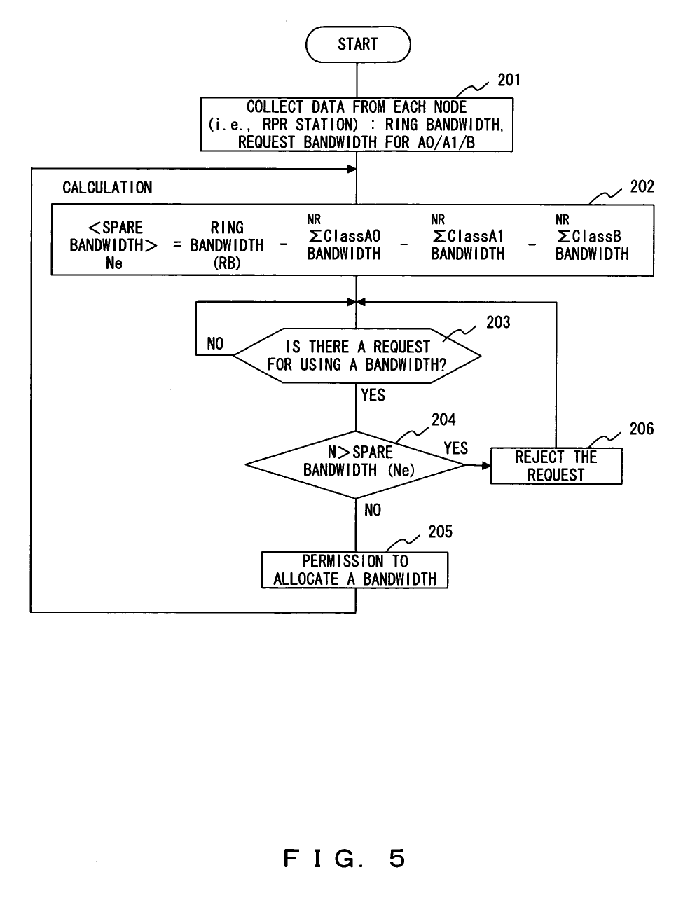

The present embodiment is configured to let the main storage 32 store a bandwidth management program 32a and carry out a bandwidth management processing as exemplified by a later described flow chart shown in FIG. 5 as a result of the MPU 31 executing the bandwidth management program 32a.

The external storage apparatus 34 is equipped by a CIR value management data base 37 for storing information such as a CIR value collected from each of the RPR stations 20 by way of the management-use information network 13.

As exemplified by FIG. 4, the CIR value management data base 37 stores pieces of information, i.e., RPR station numbers 37a, subclass A0_CIR values 37b, subclass A1_CIR values 37c, class B_CIR values 37d, et cetera.

As described above, the RPR is capable of giving three priorities, that is, classes A, B and C, to a frame propagating in the RPR ring 10. Absolute assurance of a transmission bandwidth is required for the class A and B frames in order to send the frames to the RPR ring 10 from the RPR stations on the RPR ring, which is called as a CIR (Committed Information Rate) In order to absolutely assure a transmission bandwidth defined as a CIR, the total of CIRs defined at the respective RPR stations 20 existing on the RPR ring 10 must be smaller than a physical transmission bandwidth thereof (noted as “ring bandwidth RB” hereinafter).

The present embodiment is configured in such a manner that the network management system 30 centrally manages a CIR value for each of the plurality of RPR stations 20 by using the CIR value management data base 37 thereby controlling the total of CIRs defined at the RPR stations 20 to be smaller than a physical transmission bandwidth of the RPR ring 10.

In the CIR value management data base 37, the RPR station number 37a stores the RPR station number uniquely given to each of the RPR stations 20 connected to the RPR ring 10. The subclass A0_CIR value 37b and subclass A1_CIR value 37c store respective CIR values of the subclass A0 and subclass A1 of the class A for an RPR station 20 identified by the corresponding RPR station number 37a. Likewise, the class B_CIR value 37d stores a CIR value of the class B for an RPR station 20 identified by the corresponding RPR station number 37a.

The user interface 35, comprising a keyboard and a display for example, is used for displaying information such as a content of the CIR value management data base 37 and for inputting information at the time of a system manager of the network management system 30 working on its management.

As described above, the present first embodiment centralizes the CIRs for the plurality of RPR stations 20 by using the network management system 30 capable of collecting and managing the pieces of information such as the setup information, operating states, et cetera, of all the RPR stations 20 existing on the RPR ring 10. The network management system 30 is capable of collecting individual CIR setup information from all the RPR stations 20 existing on the RPR ring 10 and integrally managing those pieces of information in the CIR value management data base 37.

The bandwidth management program 32a stored by the network management system 30 has the function of reading respective CIR values of the subclass A0, subclass A1 and class B set up for each of the RPR stations 20 out thereof.

And the network management system 30 simultaneously collects information on a physical transmission bandwidth (i.e., a ring bandwidth RB) possessed by the RPR ring 10 from the RPR station 20.

For example, the data base comprised by the network management system 30 for managing the RPR ring network shown by FIG. 2 manages the CIR information of each RPR station 20 as shown by FIG. 4.

That is, in the example shown by FIGS. 2 and 4, the CIR values of the subclasses A0 and A1 and class B are m1, 11 and k1, respectively, for the RPR station 20 by the RPR station number 37a being “2-1”, and these CIR values are recorded in the subclass A0_CIR values 37b, subclass A1_CIR values 37c and class B_CIR value 37d for the “2-1” of the RPR station numbers 37a in the CIR value management data base 37.

The network management system 30 is capable of grasping the total of the CIR values reserved for the entirety of the RPR ring 10 and comprehending a spare capacity of transmission bandwidth thereof by using the CIR value management data base 37.

If a CIR setup is made exceeding the transmission bandwidth of the RPR ring 10, the network management system 30 issues a warning to an applicable RPR station.

The following description is of an example operation of the network management system 30 according to the present embodiment by referring to the flow chart shown by FIG. 5, et cetera.

First, the network management system 30 collects information on the ring bandwidth RB of the RPR ring 10 and on the CIR setup conditions of the respective classes (i.e., subclasses A0 and A1, and class B) from each of the RPR stations 20, and stores in the CIR value management data base 37 (step 201).

Next is to calculate a spare bandwidth Ne by subtracting the ring bandwidth RB from the total of the usage bandwidth for the each class at each of the RPR stations 20 (the total of RPR stations 20=NR) at the moment (step 202).

Then, when an additional request for bandwidths for the subclasses A0, A1 and class B occurs at a random RPR station 20 (step 203), the network management system 30 judges whether the additionally requested bandwidth N exceeds the current spare bandwidth Ne (step 204) and, if it exceeds, rejects the additional request for the request bandwidth N and issues a warning to the requester (step 206) followed by going back to a standby for additional request for a new bandwidth.

If the requested bandwidth N is smaller than the spare bandwidth Ne in the judgment of the step 204, judges that an allocation of the additional request for the requested bandwidth is possible and gives a permission to allocate the requested bandwidth N (step 205), followed by going back to the step 202 and recalculating a spare bandwidth Ne in preparation for a next allocation request.

### Second Embodiment

While the above described first embodiment has exemplified the case of the network management system 30 collecting and managing a CIR value for each of the RPR stations 20, the second embodiment exemplifies the case of each of a plurality of RPR stations 20 mutually exchanging a setup value of a CIR and each thereof managing the CIR value. Note that the basic configuration of an information network system is the same as FIG. 2, and that the same component number is assigned to the same component whose description is omitted.

An RPR station 20 conventionally notifies other RPR stations of a setup value of the CIR only for the subclass A0 and the system of all the RPR stations 20 existing in an RPR ring 10 grasping the subclass A0 CIR bandwidth of the entire RPR ring 10 is standardized by the IEEE 802.17.

The present embodiment exemplifies the case of an RPR station 20 having the functions of notifying other RPR stations 20 also of CIR information of the subclass A1 and class B, receiving the similar information from the other RPR stations 20, and preventing a CIR setup exceeding a spare capacity from being carried out by calculating a spare capacity of the transmission bandwidth of the RPR ring 10 from the aforementioned information.

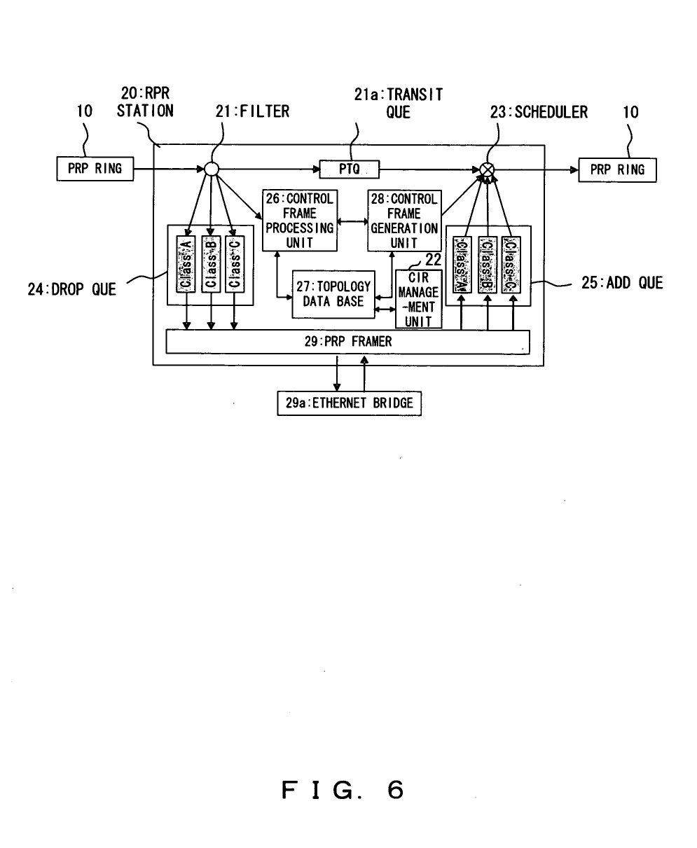

FIG. 6 exemplifies a configuration of each of the RPR stations 20 according to the present second embodiment. Each of the RPR stations 20 connected to the RPR ring 10 includes a filter 21, a transit queue 21a, a CIR management unit 22, a scheduler 23, a Drop queue 24, an Add queue 25, a control frame processing unit 26, a topology data base 27, a control frame generation unit 28, an RPR framer 29 and an Ethernet (registered trademark) bridge 29a.

The CIR management unit 22, control frame processing unit 26, topology data base 27 and control frame generation unit 28 for example can be implemented by a control program such as software, firmware, et cetera, of a computer constituting an RPR station 20.

A data frame of an RPR frame coming in from the RPR ring 10 is imported by the Drop queue 24 by each class and added information is removed by the RPR framer 29, followed by being handed over to the corresponding router 60 by way of the Ethernet bridge 29a.

Conversely, transmission data coming in from the router 60 is structured as an RPR frame by the RPR framer 29, stored in the Add queue 25 by each class and sent out to the RPR ring 10 at a transmission timing controlled by the scheduler 23.

A frame simply passing through the RPR ring 10 is once retained by the transit queue 21a and then sent out to the RPR ring 10 at a transmission timing controlled by the scheduler 23.

As described above, an RPR frame coming from the RPR ring 10 is sorted by the filter 21, that is, a data frame is sorted into the Drop queue 24, while a control frame is sorted into the control frame processing unit 26.

The control frame includes a so-called topology frame for indicating an operating state and setup state of other RPR stations, with the topology frame including a subclass A0 CIR value as information. These pieces of information are extracted and managed in the topology data base 27 for each RPR station 20. And the control frame generation unit 28 is a functional block for generating a topology frame for the purpose of notifying other RPR stations 20 of topology data of the own station. The subclass A0 CIR setup value of the own station is mounted to the topology frame in this event and notified to the other RPR stations 20.

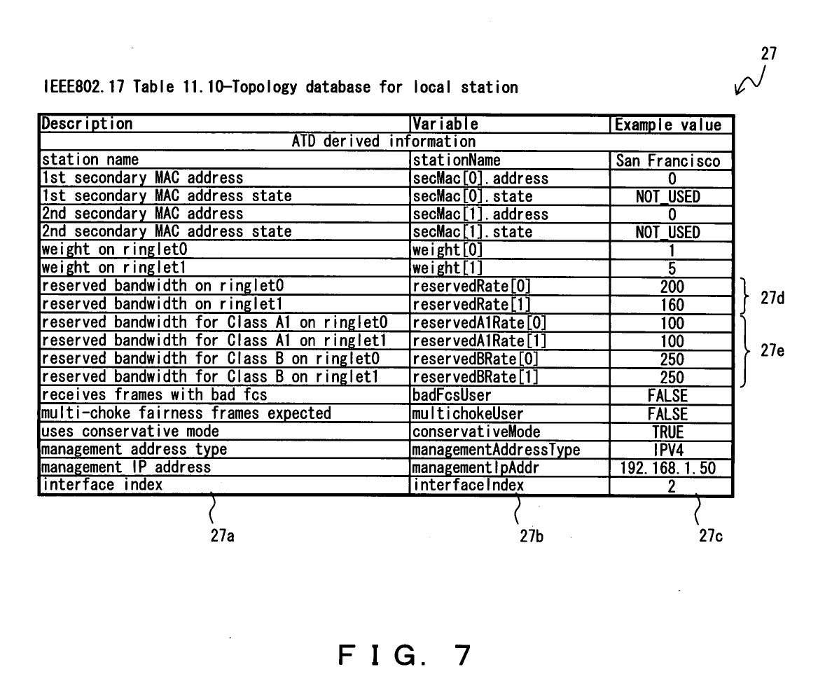

As exemplified by FIG. 7, the topology database 27 includes a description 27a, a variable 27b and a setup value 27c. The present second embodiment comprises a management item 27e (i.e., a reservedA1Rate [0], a reservedA1Rate [1], a reservedBRate [0] and a reservedBRate [1]) for the purpose of managing the subclass A1 and class B CIRs in addition to a management item 27d (i.e., a reservedRate [0] and a reservedRate [1] for the purpose of managing the conventional class A0 CIR value.

This configuration enables each of the RPR stations 20 to manage all the CIRs of not only the conventional class A0, but also those of the subclass A1 and class B.

A frame for carrying topology information among the RPR station 20 uses an ATD (Attribute Discovery) frame whose frame format, header information and ATD information are all defined by the chapter 11.3.5 and chapter 11.4 of the IEEE 802.17.

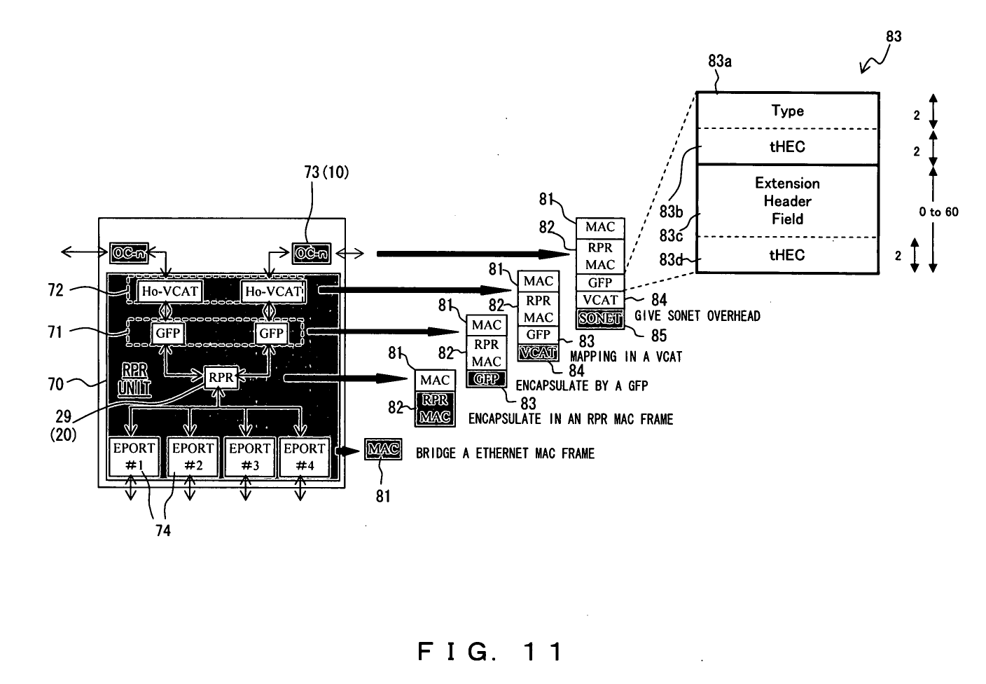

Information of the subclass A1 CIR and class B CIR is notified to the RPR ring 10 by means of an ATD frame which allows a definition of information carried by the ATD frame by a type field of the typeLengthValue field shown by the IEEE 802.17—FIG. 11.14 (refer to IEEE 802.17—FIG. 11.15) (refer to IEEE 802.17—Table 11.7). Among them, pieces of information on the subclass A1 CIR and class B CIR are notified by using the Organization-specific ATT shown by the chapter 11.4.8 of the IEEE 802.17.

The Organization Data field shown by the IEEE 802.17—FIG. 11.23 writes the information as follows:

1) Subclass A1 or class B

2) CIR setup value of the ringlet 0 and ringlet 1 Having received the frame, the RPR station 20 writes the CIR information in the topology data base 27.

If all pieces of the topology data of the RPR ring 10 are lined up in the topology data base 27, the CIR management unit 22 of the RPR station 20 is able to grasp an accurate spare capacity (i.e., a spare bandwidth Ne) of the transmission bandwidth (i.e., a ring bandwidth RB) for the RPR ring 10.

The present second embodiment is configured so that the CIR management unit 22 rejects a setup and issues a warning to the setter by an appropriate alarm if a random RPR station 20 existing in the RPR ring 10 tries to set up a CIR requiring larger bandwidth than the spare capacity (i.e., a spare bandwidth Ne) of the RPR ring transmission bandwidth.

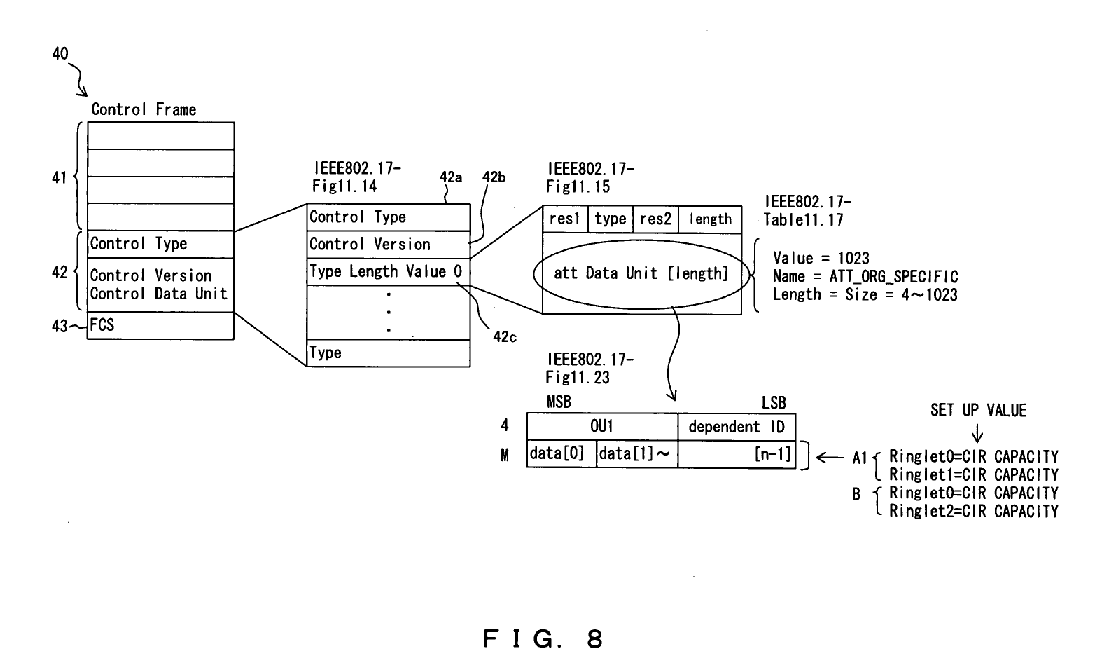

FIG. 8 is a conceptual diagram exemplifying a structure of a control frame for exchanging information of the subclass A1 CIR and class B CIR among each of the RPR stations 20 by using the control frame 40 as described above according to the present second embodiment.

The control frame 40 includes a control header 41, an attribute discovery payload 42 and a frame check sequence 43.

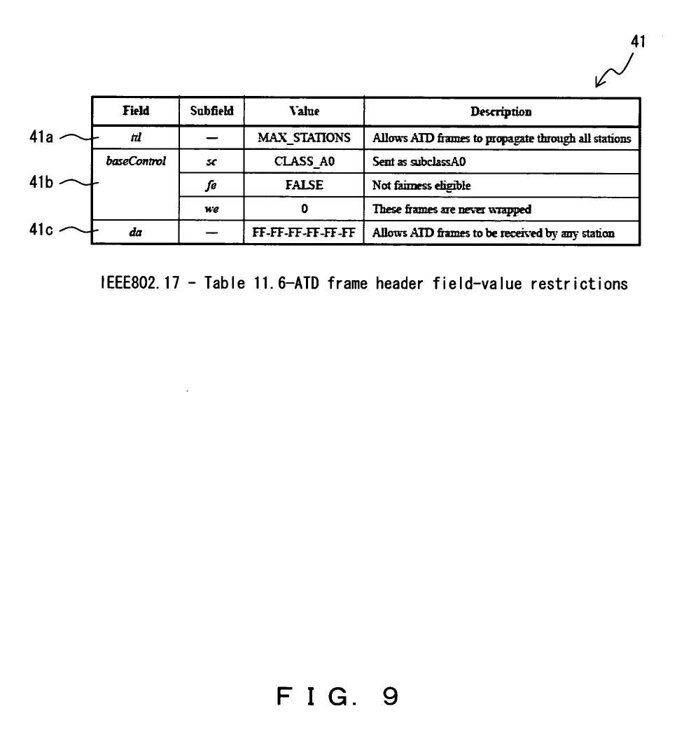

The control header 41 has the structure exemplified by FIG. 9. That is, the control header 41 includes a tt1 field 41a for controlling a reaching life within an RPR ring 10, a baseControl field 41b storing control information and a da field for indicating an address (i.e., a broadcast in this case).

The attribute discovery payload 42 includes a control type 42a, a version 42b and a type length value 42c.

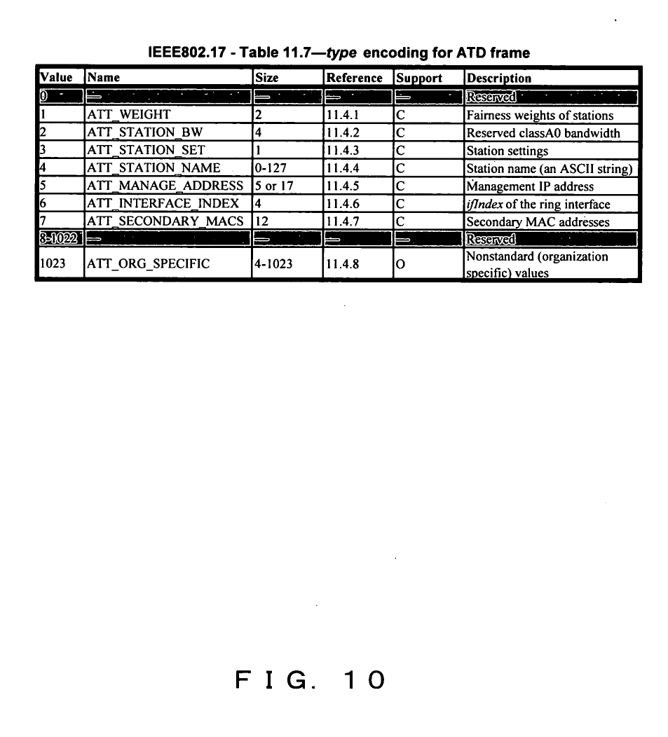

The type length value 42c is segmented to the respective fields, i.e., “res1”, “type”, “res2” and “length” and is set by an attDataUnit [length]. The present embodiment is configured to set the value=1023, Name=ATT_ORG_SPECIFIC (defined name of a tag), Length=Size=4 through 1023 among the type encoding exemplified by FIG. 10.

And the part of the attDataUnit [length] is set up by the respective CIR capacities of the ringlet 0 and ringlet 1 for the subclass A1 and those of the ringlet 0 and ringlet 1 for the class B as indicated by the data [0], data [1] through data [n-1] as the “organizationData”.

And such control frames 40 are exchanged among the RPR stations 20, and recorded in the management item 27d and management item 27e of the topology database 27, thereby enabling the CIR management units 22 of all the RPR stations 20 connected to the RPR ring 10 to manage not only the subclass A0 CIR value but also the subclass A1 and class B CIR values.

### Third Embodiment

In the case of transmitting information by building an RPR ring 10 on a SONET/SDH, transmitting it as an RPR/over/GFP/SONET by using a GFP (Generic Framing Procedure) frame is common.

While the above described second embodiment notifies the information of the subclass A1 CIR and class B CIR by an ATD frame (i.e., a control frame 40), in the case of using a GFP frame, however, an Extension Header of the GFP frame can also be used as a method for notifying other RPR stations of the information of the subclass A1 CIR and class B CIR.

FIG. 11 is a conceptual diagram exemplifying a configuration of an RPR unit 70 for carrying out an operation of structuring a frame when sending the frame by layering as described above.

The RPR unit 70 contains RPR stations 20 connected to a plurality of Ethernet ports 74, and comprises a GEP framer 71 and a VCAT framer 72. The VCAT framer 72 is connected to an optical communication medium 73 on which an RPR ring 10 is built.

That is, the RPR framer 29 within the RPR station 20 encapsulates a MAC frame 81 in an RPR_MAC frame 82, and the GEP framer 71 further encapsulates the RPR_MAC frame 82 in a GFP frame 83.

The VCAT framer 72 maps the GFP frame 83 in a VCAT frame 84 of the VCAT (Virtual Concatenate), and further encapsulates the VCAT frame 84 in a SONET frame 85 and exchanges with the optical communication medium 73.

That is, the GFP frame 83 includes a type field 83a, a type field error check & correction unit 83b, an extended header field 83c and an extended header field error check & correction unit 83d.

The present third embodiment is configured to mount the setup values of the subclass A1 and class B CIRs relating to the ringlets 0 and 1 at each of the RPR stations 20 constituting the above described RPR ring 10 on a part of the GFP frame 83 (i.e., the extended header field 83c in this case) and notify all the other RPR stations 20 within the RPR ring 10.

Note that a usage method of the extended header field 83c for the GFP frame 83 is to allocate a specific part of the extended header field 83c from the head part down sequentially per each of the RPR stations 20 by using the above described RPR station number 37a for example, and to store the setup values of the subclass A1 and class B CIRs relating to the own station in the specific part allocated to the own station over at each of the RPR stations 20.

This configuration enables each of the RPR stations 20 to identify as to which RPR station 20 a setup value of a CIR belongs to by using an offset value from the head part of the specific part in the extended header field 83c.

As described thus far, the above described each embodiment according to the present invention enables each RPR station 20 to recognize information on the subclass A1 and class B CIRs of the other RPR stations 20 accurately if all the RPR stations 20 within the RPR ring 10 integrally comprise either one mechanism of the above described first, second or third embodiments. This prevents a wrong setup of a CIR exceeding the physical transmission bandwidth of the RPR ring 10 (i.e., the ring bandwidth RB), which means that the RPR ring 10 comprises a capability of providing the end users connecting to each of the RPR stations 20 with a class B service assuring a complete bandwidth by way of the router 60.

Note that it goes without saying that the present invention can be changed variously within the scope thereof in lieu of being limited to the configurations exemplified by the above described embodiments.

The present invention enables an accurate management of the total bandwidth given to each layer of priorities for frames which are exchanged among telecommunication nodes based on the physical bandwidth of an information network therein in which the priorities for the aforementioned frames are layered.

Also enabled is an accurate bandwidth assurance within an RPR ring for not only the subclass A0 CIR but also the subclass A1 and class B CIRs in the RPR ring.

Also enabled is a definite prevention of a wrong bandwidth assurance in consideration of not only the subclass A0 CIR but also the subclass A1 and class B CIRs in the RPR ring.

What is claimed is:

1. A control method for an information network connecting a plurality of telecommunication nodes by a ring transmission path and giving a plurality of priorities to frames which are exchanged among the telecommunication nodes, comprising the processes of:
recognizing a bandwidth assurance value set up for each of the telecommunication nodes on the ring transmission path for each layer of the priorities; and
judging whether or not a sum of the total of the bandwidth assurance value at the present and a newly allocated value of the bandwidth assurance value exceeds a physical transmission bandwidth of the ring transmission path when a discretionary one of the telecommunication nodes accepts an allocation of the bandwidth assurance value anew.

2. The control method for an information network according to claim 1, wherein
said ring transmission path is an resilient packet ring (RPR) compliant to the IEEE 802.17; said layer comprises a class A, which is made up of a subclass A0 and subclass A1, and a class B; and said bandwidth assurance value is recognized for the class A and class B.

3. A control method for an information network connecting a plurality of telecommunication nodes by a ring transmission path and giving a plurality of priorities to frames which are exchanged among the telecommunication nodes, comprising the processes of:
collecting a bandwidth assurance value set up for each of the telecommunication nodes on the ring transmission path for each layer of the priorities by a network management apparatus which manages the telecommunication nodes; and
judging whether or not a sum of the total of the bandwidth assurance value at the present and a newly allocated value of the bandwidth assurance value exceeds a physical transmission bandwidth of the ring transmission path by the network management apparatus when a discretionary one of the telecommunication nodes accepts an allocation of the bandwidth assurance value anew.

4. The control method for an information network according to claim 3, wherein
said ring transmission path is an resilient packet ring (RPR) compliant to the IEEE 802.17; said layer comprises a class A, which is made up of a subclass A0 and subclass A1, and a class B; and said bandwidth assurance value is collected for the class A and class B.

5. A control method for an information network connecting a plurality of telecommunication nodes to a ring transmission path and giving a plurality of priorities to frames which are exchanged among the telecommunication nodes, comprising the processes of:
notifying all the telecommunication nodes of a bandwidth assurance value set up for each of the telecommunication nodes on the ring transmission path for each layer of the priorities; and
judging whether or not a sum of the total of the bandwidth assurance value at the present and a newly allocated value of the bandwidth assurance value exceeds a physical transmission bandwidth of the ring transmission path when a discretionary one of the telecommunication nodes accepts an allocation of the bandwidth assurance value anew.

6. The control method for an information network according to claim 5, wherein
said ring transmission path is an resilient packet ring (RPR) compliant to the IEEE 802.17; said layer comprises a class A, which is made up of a subclass A0 and subclass A1, and a class B; and said bandwidth assurance value for the class A and class B is notified from one of said telecommunication nodes to the others thereof.

7. A control method for an information network connecting a plurality of telecommunication nodes by a ring transmission path and giving a plurality of priorities to first frames which are exchanged among the telecommunication nodes, comprising the processes of:
notifying all the telecommunication nodes of a bandwidth assurance value set up for each thereof in the ring transmission path for each layer of the priorities by using a part of a second frame on another protocol layer for carrying the first frame; and
judging whether or not a sum of the total of the bandwidth assurance value at the present and a newly allocated value of the bandwidth assurance value exceeds a physical transmission bandwidth of the ring transmission path when a discretionary one of the telecommunication nodes accepts an allocation of the bandwidth assurance value anew.

8. The control method for an information network according to claim 5, wherein
said ring transmission path is an resilient packet ring (RPR) compliant to the IEEE 802.17, and said second frame is the one compliant to a generic framing procedure (GFP) for carrying said first frame based on said resilient packet ring by including it.

9. A telecommunication node for constituting an information network by connecting itself to a ring transmission path and giving a plurality of priorities to frames flown in the network, comprising:
a notification unit for notifying the other telecommunication nodes of a bandwidth assurance value set up for the own telecommunication node on the ring transmission path for each layer of the priorities;
a storage unit for storing the bandwidth assurance values for all the telecommunication nodes connected to the ring transmission path; and
a judgment unit for judging whether or not a sum of the total of the bandwidth assurance value in a plurality of the telecommunication nodes at the present and a newly allocated value of the bandwidth assurance value exceeds a physical transmission bandwidth of the ring transmission path when the own telecommunication node accepts an allocation of the bandwidth assurance value anew.

10. The telecommunication node according to claim 9, wherein
said ring transmission path is an resilient packet ring (RPR) compliant to the IEEE 802.17; said layer comprises a class A, which is made up of a subclass A0 and subclass A1, and a class B; and said storage unit stores said bandwidth assurance value relating to the class A and class B.
